(19) United States
(12) Patent Application Publication
(10) Pub. No.: US 2023/0046333 A1
(43) Pub. Date: Feb. 16, 2023

(54) Force-Based Peripheral Control Toggle

(71) Applicant: Google LLC, Mountain View, CA (US)

(72) Inventor: Jonathan D. Hurwitz, San Jose, CA (US)

(21) Appl. No.: 17/399,565

(22) Filed: Aug. 11, 2021

(51) Int. Cl. G04G 21/08; G02B 27/01; G06F 3/0488; G06F 1/16

(52) U.S. Cl. CPC G04G 21/08; G02B 27/017; G06F 3/0488; G06F 1/163; G02B 2027/0178; H04W 4/80

(57) ABSTRACT

A smartwatch is configured to be usable to control a peripheral device. The smartwatch can be toggled between a typical or usual operating mode for a smartwatch and a mode for controlling the peripheral device. The toggling function is bound to a virtual button. Force applied to the virtual button is measured so that multiple functions, including the toggling function, can be accessed by applying different amounts of force to the button for a predetermined amount of time.

### BACKGROUND

Peripherals that do not have controls conveniently accessible to a user, such as speakers, televisions or other displays, or virtual reality (“VR”) or augmented reality (“AR”) glasses, may require the user to perform an uncomfortable, inconvenient action to control. For this among other reasons, such peripherals may benefit from separate, remote controllers. Applications or “apps” exist for smartphones and certain other devices for controlling some types of electronics, but navigating to an app can be cumbersome and time consuming. Further, smart phones usually need to be held in hand, which could interrupt a work flow that the peripheral was intended to facilitate. Enabling quick access to peripheral controls on easily handled devices could therefore be more convenient than the state of the art for some use cases.

### BRIEF SUMMARY

Aspects of this disclosure are directed to a smartwatch that may be used to control a peripheral device. The smartwatch may be configured to toggle between a typical or usual operating mode for a smartwatch and a mode for controlling the peripheral device. The smartwatch may control the peripheral device based on user inputs to any one or any combination of a touch screen, crown, or button of the smartwatch while the smartwatch is in the peripheral control mode. A crown here refers, for example, to any one or any combination of a rotary mechanical input, a simple mechanical button, a stem that may be pulled out or pushed in to various degrees relative to the watch case, or any other structure, combination of structures, input, or combination of inputs referred to as a crown in any known type of mechanical, digital, or smartwatch. Further, the crown may be located at any location upon a watch case where crowns have been located in known mechanical, digital, or smartwatches. When in the peripheral control mode, the smartwatch may display a control interface for the peripheral device.

The smartwatch may include a button and be configured to measure force applied to the button. Different functions may be executed depending on the amount of force applied to the button and the duration of time for which the force is applied to the button. Various functions may be executed either immediately after the corresponding force has been applied for a sufficient time or when the force is removed from the button after the force has been applied for the sufficient amount of time. Haptic feedback may be used to signal to a user when force has been applied to the button in a magnitude that corresponds to a function or for a sufficient amount of time to trigger a function. The button may be a virtual button, such as a portion of a case of the smartwatch that is measured by a strain gauge.

In another aspect, a smartwatch may comprise a button and a strain gauge configured to measure force applied to the button. The smartwatch may be configured to toggle between a first mode for controlling a peripheral device and a second mode when force within a predefined force range is measured by the strain gauge for a predefined period of time.

In another arrangement according to any of the foregoing, the second mode may include presenting a smartwatch interface on a display of the smartwatch.

In another arrangement according to any of the foregoing, the predefined force range may be a first force range and wherein the smartwatch is configured to execute a function other than toggling between the first mode and second mode when force within a second force range is measured by the strain gauge for a predefined period of time.

In another arrangement according to any of the foregoing, the smartwatch may be configured to provide haptic feedback when force within the first force range or the second force range is measured by the strain gauge.

In another arrangement according to any of the foregoing, the smartwatch may be configured to provide haptic feedback of a first magnitude when force within the first force range is measured and haptic feedback of the second magnitude when force within the second force range is measured, and the first magnitude is greater than the second magnitude.

In another arrangement according to any of the foregoing, the second force range may have an upper end that is below a lower end of the first force range.

In another arrangement according to any of the foregoing, the button may be a virtual button.

In another arrangement according to any of the foregoing, the smartwatch may include a case, the button is a portion of the case, and the strain gauge is configured to measure deformation of the portion of the case.

In another arrangement according to any of the foregoing, the peripheral device may be a pair of virtual reality or augmented reality glasses. In further arrangements according to any of the foregoing, the peripheral device may be any other electronic device controllable by a smart device.

In another arrangement according to any of the foregoing, the smartwatch may be configured to control a user interface of the glasses based on user inputs to the smartwatch when the smartwatch is in the first mode.

In another arrangement according to any of the foregoing, the smartwatch may include a crown, and inputs to the crown are among the inputs on which control of the user interface of the glasses is based.

In another arrangement according to any of the foregoing, the smartwatch may include a touch screen, and inputs to the touch screen are among the inputs on which control of the user interface of the glasses is based.

In another arrangement according to any of the foregoing, the predefined period of time may be at least two seconds.

In another arrangement according to any of the foregoing, the force range may not have an upper limit.

In another aspect, a method of using a smartwatch, may comprise applying force to a button of the smartwatch to toggle between a first mode for controlling a peripheral device and a second mode.

In another arrangement according to any of the foregoing, the method may also comprise controlling the peripheral device by submitting inputs to the smartwatch while the smartwatch is in the first mode.

In another arrangement according to any of the foregoing, the peripheral device may be a pair of virtual reality or augmented reality glasses.

In another arrangement according to any of the foregoing, the inputs may include turning or pressing a crown of the smartwatch.

In another arrangement according to any of the foregoing, the button may be a portion of a case of the smartwatch.

In another arrangement according to any of the foregoing, the smartwatch may include a strain gauge continued to measure force applied to the button, and wherein the force is applied in a non-zero magnitude within a predetermined force range to the button for at least two seconds, and the toggling occurs after the two seconds have elapsed.

### BRIEF DESCRIPTION OF THE DRAWINGS

FIG. 1 illustrates a smartwatch being operated by a user according to aspects of the disclosure.

FIG. 2 is a diagram of a pressure based function selection system according to aspects of the disclosure.

FIG. 3 is a diagram of a control toggle system according to aspects of the disclosure.

### DETAILED DESCRIPTION

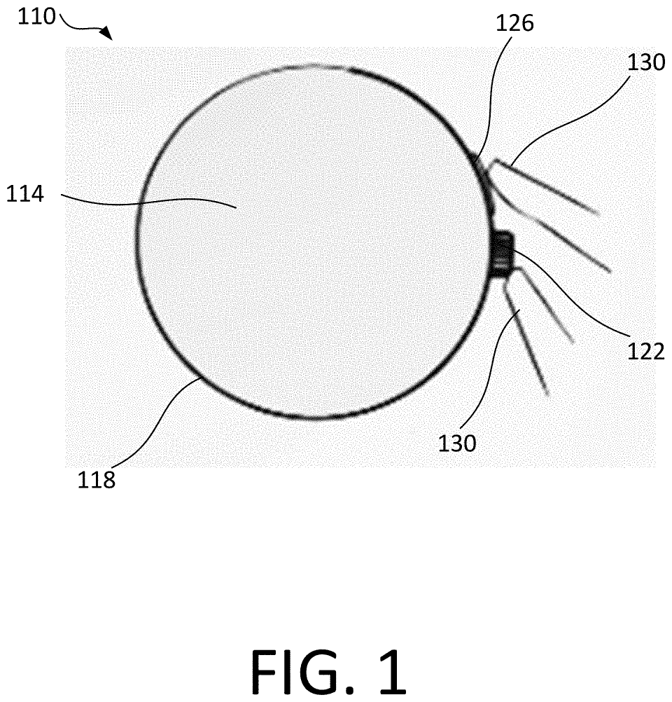

FIG. 1 illustrates a smartwatch 110 having a face 114 encircled by a bezel or case 118. Smartwatch 110 may include a processor and a non-transitory, computer readable medium carrying instructions that, when executed by the processor, cause the processor to receive any of the inputs, generate any of the outputs, or execute any of the logic or functions, described within the present disclosure, individually or in any combination. Face 114 is a touch screen, and may therefore display a varying set of touch based controls. The variability of such touch based controls enables a specific interface to be created for each of a wide variety of applications, but may cause momentary hesitation when a user 130 tries to find buttons within a given interface. By contrast, user 130 can usually readily locate specific hardware features or location on smartwatch 110 regardless of Further, each virtual control must occupy part of a finite amount of screen space. For these reasons, among others, smartwatch 110 may include some physical, hardware based controls. However, all hardware, methods, description, and examples in this disclosure may also be applied to or implemented in smartphones, tablets or other types of smart devices.

One such hardware based control is crown 122. According to various examples, crown 122 may be able to receive inputs of rotation, pressure, other inputs, or any combination thereof. Nonetheless, the number of inputs for which crown 122 may intuitively be used is limited, so other hardware based controls may be provided on smartwatch 110 in addition or in the alternative to the crown.

One such additional hardware based control is a button 126. Button 126 may be a conventional mechanical button or may be a virtual button created by pressure sensitivity at a certain point on bezel or case 118. Smartwatch 110 may include any type of hardware for measuring force applied to button 126. Suitable hardware includes any design capable of measuring strain as a strain gauge. The strain gauge may be configured to measure force applied to button 126 by being placed so as to measure deformation of button 126 itself or another element that deforms when force is applied to button 126. The gauge itself or smartwatch's 110 processor may convert the measured strain to force, so throughout this disclosure references to measurement of force by a strain gauge mean the quantity of force found by converting the strain measured by the strain gauge into units of force. In configurations wherein button 126 is a virtual button, the strain gauge may be arranged to measure strain on a specific point or area on case 118 to create the virtual button at the measured point or area by measuring force applied there without having the multiple moving parts included in typical mechanical buttons. The location of a virtual button may be marked by indentations or protrusions formed in case 118 or by an image printed on case 118. The measured force may be transduced, such as, for example, by processing the strain gauge output through either or both of an analog front end (“AFE”) device and an analog to digital converter (“ADC”) device. In arrangements including both an AFE and an ADC, the strain gauge output may be processed through the AFE first, then through the ADC. Different functions may be tied to different amounts of force applied to button 126 as measured by the strain gauge.

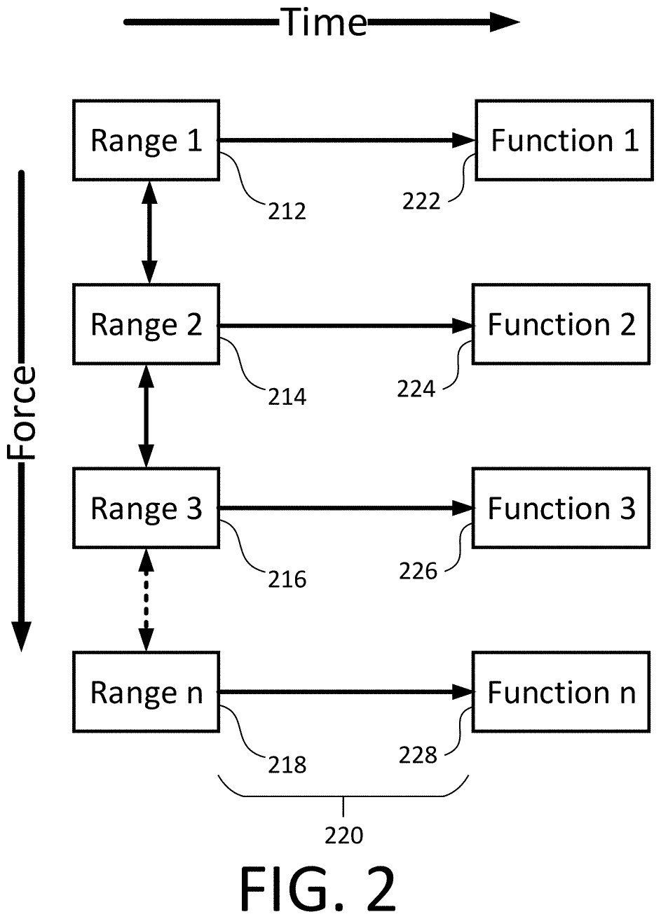

FIG. 2 illustrates a force based function selection system usable with a force-measured hardware control, such as button 126. Instructions for a processor to carry out the function selection system and any variations described here may be stored within a non-transitory computer readable medium within smartwatch 110 or any other computing device including a suitable force-measured hardware control. In the arrangement of FIG. 2, a function may be triggered after force within a corresponding range is applied to button 126 or other force-measured hardware control for at a confirmation time 220, which is a predetermined, non-zero amount of time. For example, if force of a magnitude within a first range 212 is applied for a confirmation time 220, a first function 222 may be executed at or after the end of the confirmation time. Likewise, if applied for the length of confirmation time 220, force within a second range 214 may trigger a second function 224 and force within a third range 216 may trigger a third function 226. In various examples, any number of force ranges with corresponding functions may be used. The force ranges may be contiguous with, overlapping with, or spaced apart from one another. A highest force range 218 tied to a highest force function 228 may be defined either between two force thresholds, or may have only a lower force threshold and no upper limit.

Confirmation time 220 may be different or the same between all or any subset of the force thresholds. Any or all of the functions may be preceded by a prompt that appears when force within the corresponding force range is applied to the force-measured control and advises a user that a function will be executed if force is maintained. Alternatively, confirmation time 220 for any or all functions 222, 224, 226, 228 may be relatively short such that a user would perceive a given function to be executed immediately, or almost immediately, after force within the corresponding range is applied to the force-measured control.

Functions 222, 224, 226, 228 may be executed immediately at the end of confirmation time 220 or may be executed when force upon button 126 or other force-measured control is removed after confirmation time is elapsed. Different functions may be executed depending on how long force within a given force range is applied before being removed. A given force range could be assigned both functions set to be executed only upon removal of force within a certain time range and functions set to be executed immediately when force is applied for a certain amount of time in any quantity and order, and such times and time ranges may be of any length.

Smartwatch 110 may provide haptic feedback as user 130 navigates the force based function selection system of FIG. 2. A haptic feedback event may occur as force upon button 126 or other force-measured control moves into and/or out of any force range 212, 214, 216, 218, or when confirmation time 230 has elapsed. The haptic feedback may differ across force ranges. For example, the magnitude of the haptic feedback may be greater for higher force ranges than for lower force ranges. The magnitude of the haptic feedback may also differ between functions, such as by being greater in magnitude when functions associated with higher force ranges or greater confirmation times are triggered.

One example implementation of the force selection system of FIG. 2 as applied to smartwatch 110 is wherein first force range 212 is a “light press” defined as no less than 0.1 N but less than 0.3 N, second force range 214 is a “medium press” defined as no less than 0.3 N but less than 0.6 N, and third force range 216 is a “hard press” defined as 0.6 N or greater. In this example, no force range above third force range 216 is defined. Further according to this example, first function 222 is any function usually triggered by a conventional mechanical button on a mechanical watch, such as a chronograph function, second function 224 is a smart device function that may be useful to have readily accessible, such as opening a quick access menu, starting a workout routine within a workout app, or accessing a payment app, and third function 226 toggles smartwatch 110 between a standard control mode and a peripheral control mode. Still further according to the present example, confirmation time is 2 seconds, 3 seconds, or any time between 2 and 3 seconds. Any one or any combination of the foregoing aspects of the present example implementation of the force selection system may be used separately from the others. Any quantities may be varied, and any of the functions may be reassigned to different force ranges.

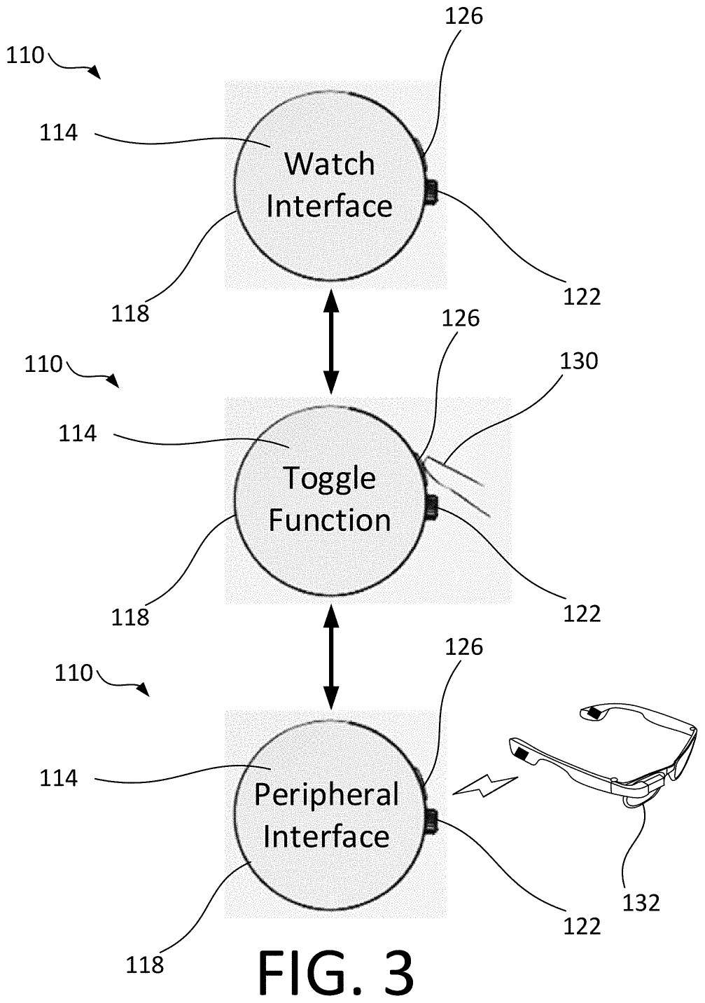

FIG. 3 illustrates toggling smartwatch 110 between modes as mentioned in the above example, though toggling as described may be implemented outside the above example. As shown, face 114 of smartwatch 110 may display either a watch interface, which is any interface presented in normal operation of a smartwatch, or a peripheral interface, which is an interface for controlling a specific peripheral device 130. In the illustrated example, peripheral device 132 is a pair of VR or AR glasses, but other examples of peripheral devices include speakers, televisions, and other displays. Peripheral devices 132 may be placed in communication with smartwatch 110 by any known digital communication technology, including wired connections and wireless connections. Example wireless connection protocols that may be used to establish digital communication between smartwatch 110 and the peripheral device 132 include near field communication and any type of Bluetooth connection, such as classic Bluetooth or Bluetooth Low Energy (“BLE”). User 130 toggles smartwatch 110 between the standard control mode, wherein face 114 displays the watch interface, and the peripheral control mode, wherein the face displays the peripheral interface, by submitting an input to the smartwatch that triggers a toggle function. The toggle function may be assigned to any input, and may therefore be any of the functions mentioned above with regard to the force based function selection system of FIG. 2 or any variations thereon. As such, in some examples, user 130 may trigger the toggle function by applying force to button 126 as illustrated. Therefore, in the illustrated example, user 130 may toggle smartwatch 110 between a standard control mode and a watch control mode by applying force to a portion of case 118 designated as virtual button 126. Whether or not any other functions are associated with unique haptic feedback, a unique haptic feedback may be provided upon toggling in either direction.

A peripheral interface on smartwatch's 110 touch screen display 114 would enable convenient access to several functions on the peripheral device 132. An implementation of such a peripheral interface for AR or VR glasses according to one example would enable user 130 to scroll in the glasses UI by dragging a finger along display 114 or rotating crown 122, to switch between menus in the glasses UI or upon display 114 by swiping across display 114, to select an option on the menu by tapping on display 114, to go back or cancel by pressing on crown 122, and to perform a quick access task by pressing button 126 with greater or less force, or for a different amount of time, than would be used to toggle smartwatch 110 back to the watch interface. The foregoing peripheral interface could also be applied to other types of peripherals, and the described functions could be reassigned to any of the other described inputs. Pushing or pulling on crown 122 may also be inputs to which functions of the peripheral device 132 are assigned when smartwatch 110 is in the peripheral control mode.

Although the concept herein has been described with reference to particular examples, it is to be understood that these examples are merely illustrative of the principles and applications of the present concept. It is therefore to be understood that numerous modifications may be made to the illustrative examples and that other arrangements may be devised without departing from the spirit and scope of the present concept as defined by the appended claims.

1. A smartwatch comprising:
a button; and
a strain gauge configured to measure force applied to the button;
wherein the smartwatch is configured to toggle between a first mode for controlling a peripheral device and a second mode when force within a predefined force range is measured by the strain gauge for a predefined period of time, and to provide haptic feedback of a first magnitude when force within a first force range is measured and haptic feedback of a second magnitude when force within a second force range is measured, the first magnitude being greater than the second magnitude.

2. The smartwatch of claim 1, wherein the second mode includes presenting a smartwatch interface on a display of the smartwatch.

3. The smartwatch of claim 1, wherein the predefined force range is the first force range and wherein the smartwatch is configured to execute a function other than toggling between the first mode and second mode when force within the second force range is measured by the strain gauge for a predefined period of time.

4. (canceled)

5. (canceled)

6. The smartwatch of claim 1, wherein the second force range has an upper end that is below a lower end of the first force range.

7. The smartwatch of claim 1, wherein the button is a virtual button.

8. The smartwatch of claim 7, wherein the smartwatch includes a case, the button is a portion of the case, and the strain gauge is configured to measure deformation of the portion of the case.

9. The smartwatch of claim 1, wherein the peripheral device is a pair of virtual reality or augmented reality glasses.

10. (canceled)

11. A smartwatch comprising:
a button; and
a strain gauge configured to measure force applied to the button;
wherein:
the smartwatch is configured to toggle between a first mode for controlling a peripheral device and a second mode when force within a predefined force range is measured by the strain gauge for a predefined period of time;
the smartwatch is configured to control a user interface of the glasses based on user inputs to the smartwatch when the smartwatch is in the first mode; and
the smartwatch includes a crown, and inputs to the crown are among the inputs on which control of the user interface of the glasses is based.

12. The smartwatch of claim 11, wherein the smartwatch includes a touch screen, and inputs to the touch screen are among the inputs on which control of the user interface of the glasses is based.

13. The smartwatch of claim 1, wherein the predefined period of time is at least two seconds.

14. The smartwatch of claim 1, wherein the force range does not have an upper limit.

15. A method of using a smartwatch, comprising applying force to a button of the smartwatch to toggle between a first mode for controlling a peripheral device and a second mode, and controlling the peripheral device by submitting inputs to the smartwatch while the smartwatch is in the first mode, wherein the inputs include turning or pressing a crown of the smartwatch.

16. (canceled)

17. The method of claim 15, wherein the peripheral device is a pair of virtual reality or augmented reality glasses.

18. (canceled)

19. The method of claim 15, wherein the button is a portion of a case of the smartwatch.

20. The method of claim 15, wherein the smartwatch includes a strain gauge continued to measure force applied to the button, and wherein the force is applied in a non-zero magnitude within a predetermined force range to the button for at least two seconds, and the toggling occurs after the two seconds have elapsed.
